(19) United States
(12) Patent Application Publication
(10) Pub. No.: US 2014/0168400 A1
(43) Pub. Date: Jun. 19, 2014

(54) ELECTRONIC DEVICE AND METHOD FOR MOVING DISPLAY DEVICE

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: Chun-Sheng CHEN, New Taipei (TW); Jing WANG, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 14/070,599

(22) Filed: Nov. 4, 2013

(30) Foreign Application Priority Data
Dec. 13, 2012 (CN) 2012105368595

(51) Int. Cl. H04N 5/655; G06K 9/00

(52) U.S. Cl. CPC H04N 5/655; G06K 9/00604
USPC 348/78

(57) ABSTRACT

A method for moving a display device of an electronic device includes acquiring a facial image of a user at each predetermined time interval. The display device is supported by a bracket, which is connected to a roller axle and a motor. A ratio of a height and a width of an eye area recognized from the facial image is calculated. When the calculated ratio is less than a first reference ratio, the method sends a forward movement command to the motor to control the display device to move forward. The first reference ratio is used to determine whether eyes of the user are opened normally. The method further controls the motor to stop driving the roller axle when an updated calculated ratio is greater than or equal to the first reference ratio.

### BACKGROUND

1. Technical Field

Embodiments of the present disclosure relate to movement control technology, and particularly to an electronic device and a method for moving a display device using the electronic device.

2. Description of Related Art

An electronic device having a display device can be used to watch movies, TV, videos, and the like. However, if the display device is too far away from a user, the user has to either move the display device closer or move closer to the display device. Thus, it is not convenient for the user to use the display device. Therefore, an improved method for moving a display device is desired.

### BRIEF DESCRIPTION OF THE DRAWINGS

FIG. 1 is a block diagram of one embodiment of an electronic device including a control system.

FIG. 2 is a schematic diagram of a display device of the electronic device.

FIG. 3 is a flowchart of one embodiment of a method for setting reference parameters.

FIG. 4 is a flowchart of one embodiment of a method for moving a display device using the control system of FIG. 1.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

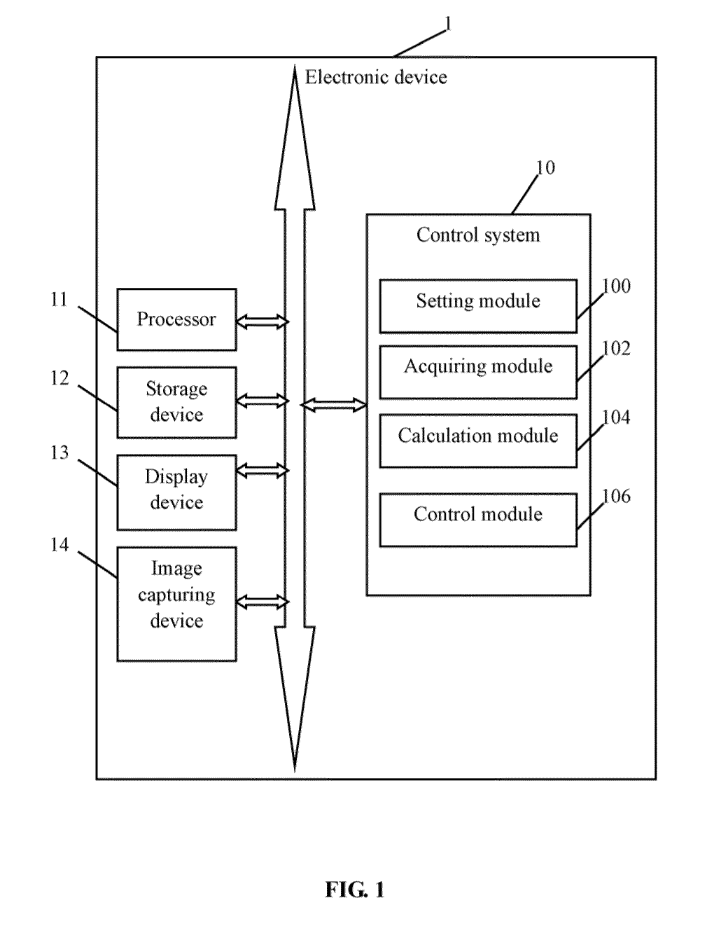

FIG. 1 is a block diagram of one embodiment of an electronic device 1 including a control system 10. The electronic device 1 can be a communication device (e.g., a mobile phone), a television (TV), a tablet computer, a personal digital assistant, a notebook computer, or any other computing device. The electronic device 1 includes at least one processor 11, a storage device 12, a display device 13, and an image capturing device 14. In other embodiments, the electronic device 1 can include more or fewer components than illustrated, or have a different configuration of the various components.

The at least one processor 11 is used to execute the control system 10 and other applications, such as an operating system installed in the electronic device 1. The storage device 12 stores one or more programs, such as the operating system and applications of the electronic device 1. The storage device 12 can be a storage card, such as a memory stick, a smart media card, a compact flash card, a secure digital card, or any other type of memory storage device.

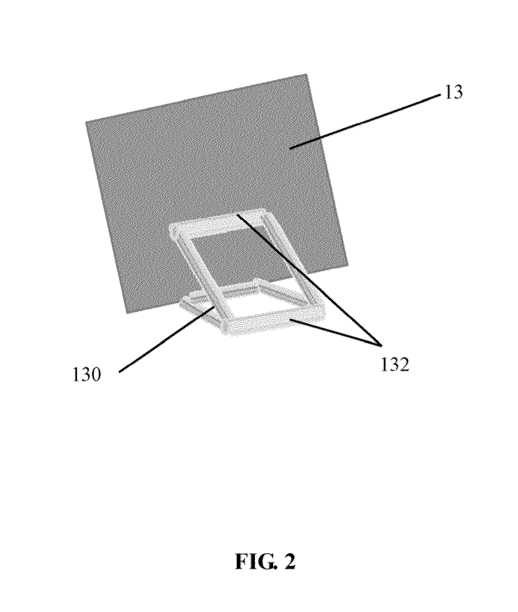

The display device 13 displays visible data, such as videos, images, or the like. In some embodiments, as shown in FIG. 2, the display device 13 is supported by a bracket 130, which has a roller axle 132. A motor is connected to the roller axle 132 and used to control movements of the roller axle 132, thereby controlling movements of the display device 13. Detailed descriptions of movement controls are provided below. The motor can be installed in the electronic device 1, the display device 13, the bracket 130, or the roller axle 132. The bracket 130 and the roller axle 132 can be disassembled. The bracket 130 and the roller axle 132 transmit data with the processor 11 through general-purpose input/output (GPIO) ports or other data connections.

In some embodiments, the bracket 130 supports the electronic device 1. In other embodiments, when the electronic device 1 and the display device 13 are separate devices, the bracket 130 supports the display device 13.

The image capturing device 14 is used to capture an image of a target object, such as a face of a user of the electronic device 1. The image capturing device 14 may be a camera.

The control system 10 controls movements of the display device 13 based on a determination as to whether eyes of the user are open or closed, so as to help the user to see the display device 13 clearly. The user may control the display device 13 remotely by opening or closing his eyes. For example, when the eyes are open, the control system 10 determines whether an open ratio (open level) of the eyes matches one or more predetermined conditions. When the open ratio of the eyes matches one of the predetermined conditions, the control system 10 controls the movements of the display device 13, such as moving forward or backwards. For another example, when the eyes are closed, the control system 10 controls the display device 13 to enter a sleep mode to save power. Detailed descriptions are provided below.

The control system 10 may include computerized instructions in the form of one or more programs that are executed by the at least one processor 11 and stored in the storage device 12. In one embodiment, the control system 10 includes one or more modules, for example, a setting module 100, an acquiring module 102, a calculation module 104, and a control module 106. In general, the word “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

Before the control system 10 is utilized to control the movements of the display device 13, a plurality of reference parameters are preset to determine whether the eyes of the user are closed or open.

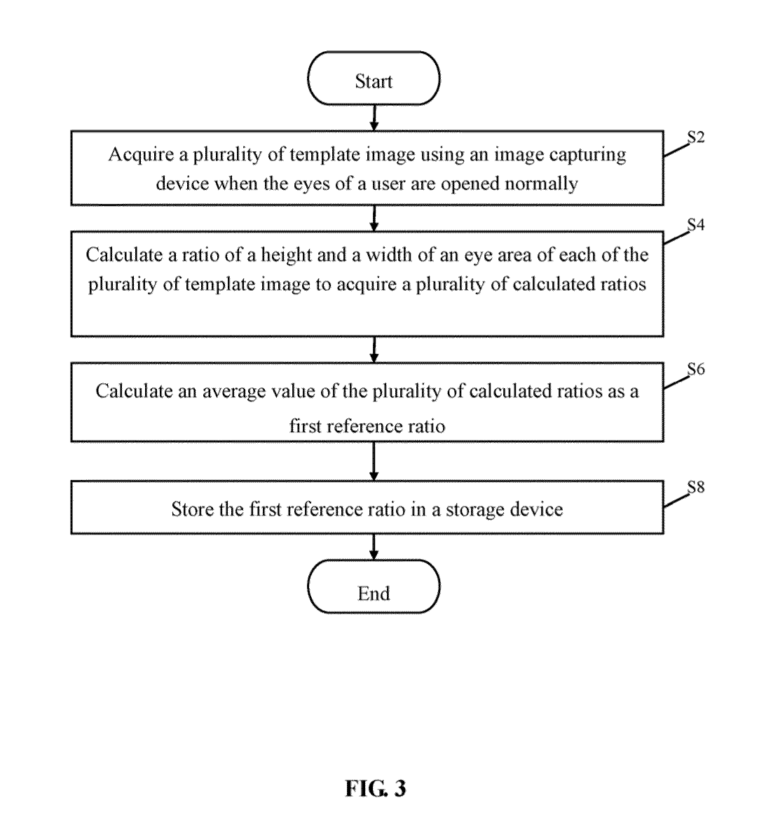

FIG. 3 is a flowchart of one embodiment of a method for setting the reference parameters. Depending on the embodiment, additional steps may be added, others removed, and the ordering of the steps may be changed.

In step S2, the image capturing device 14 captures a plurality of template images of the user (e.g., facial images or template images) when the eyes of the user are opened normally, and the acquiring module 102 acquires the template images from the image capturing device 14.

In step S4, the calculation module 104 locates an eye area on each of the template images, calculates a ratio of a height and a width of the eye area, and acquires a plurality of calculated ratios.

For example, the calculation module 104 detects a face zone in one of the template images using any known technology, and locates a rough eye area by detecting two circular shapes having a deeper color than a region of the detected face zone. When the template images are eyes image, the calculation module 104 locates the rough eye area directly without detecting any face zone. After detecting the rough eye area, the calculation module 104 utilizes an algorithm, such as the Sobel algorithm, to enhance a border of the rough eye area and further blacken the rough eye area. The rough eye area is then processed by a binarization process to determine a clear eye area. The binarization process is an image binarization algorithm based on a mathematical morphology.

The calculation module 104 samples the border of the clear eye area to obtain an outline of the clear eye area using an algorithm, such as the Snake algorithm. The outline of the clear eye area is then utilized to define an eye-rectangular representative of a maximal clear eye area. Thus, the calculation module 104 obtains a height and a width of the eye-rectangular. The height and the width of the eye-rectangular are determined to be the height and width of the eye area.

In step S6, the calculation module 104 calculates an average value of the plurality of calculated ratios of the template images, and the setting module 100 sets the average value as a first reference ratio.

In step S8, the setting module 100 stores the first reference ratio in the storage device 12.

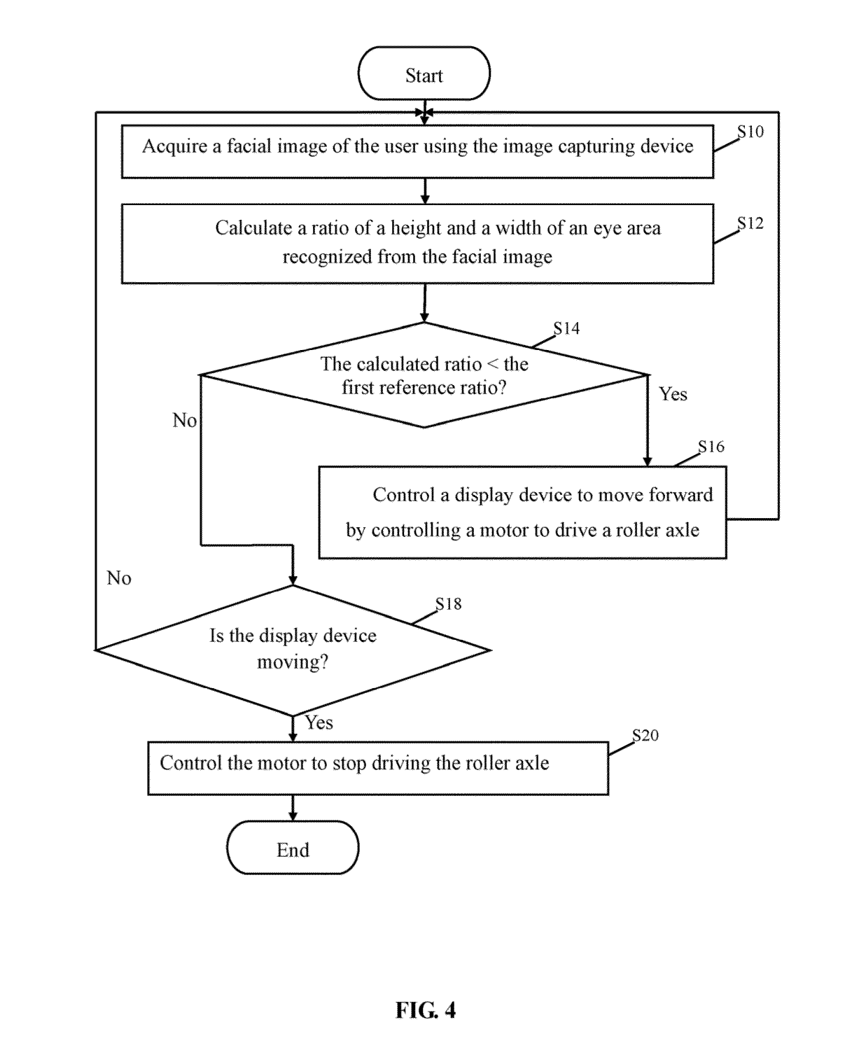

FIG. 4 is a flowchart of one embodiment of a method for moving a display device 13 using the control system 10 of FIG. 1. Depending on the embodiment, additional steps may be added, others removed, and the ordering of the steps may be changed.

In step S10, the acquiring module 102 acquires a facial image of the user at each predetermined time interval (e.g., 1 second) using the image capturing device 14. Because the control system 10 controls the display device 13 based on changes of states of the eyes of the user, a plurality of facial images are acquired according to the predetermined time interval.

In step S12, the calculation module 104 calculates a ratio of a height and a width of an eye area recognized from the facial image.

In step S14, the calculation module 104 compares the calculated ratio with the first reference ratio, and determines whether the calculated ratio is less than the first reference ratio. In some embodiments, when the calculated ratio is greater than or equal to the first reference ratio, the calculation module 104 determines that the eyes of the user are opened normally, and step S18 is implemented.

When the calculated ratio is less than the first reference ratio, the calculation module 104 determines that the eyes of the user are not opened normally, and step S16 is implemented. For example, when information displayed on the display device 13 cannot be seen clearly, the user may narrow the eyes, so the calculation module 104 determines that the calculated ratio is less than the first reference ratio.

In step S16, the control module 106 sends a forward movement command to the motor and controls the display device 13 to move forward by controlling the motor to drive the roller axle 132 according to the forward movement command. Then, the procedure returns to step S10. The forward movement command is preset by the setting module 100. For example, the roller axle 132 is controlled to roll forward to move the display device 13 forward.

The control module 106 sends the forward movement command to the motor through the GPIO ports. For example, the motor is installed in the roller axle 132, and the control module 106 sends the forward movement command through the GPIO ports of the electronic device 1 and the roller axle 132. The forward movement command may be pulse width modulation (PWM) signals to control the motor. The motor runs clockwise, counterclockwise, or stops according to different commands, such as the forward movement command, a backwards movement command, and a stop command, for example. When the motor starts running, the roller axle 132 rolls correspondingly.

It should be noted that, step S10 to step S14 are executed periodically to acquire more facial images and calculate updated calculated ratios for determining whether a state of the eyes of the user changes, until the procedure ends. For example, the user may keep narrowing the eyes until he/she can see the information on the display device 13 clearly. When the user opens the eyes normally, the control system 10 stops running the motor (see below steps S18 to S20).

In step S18, when the calculated ratio or one updated calculated ratio is greater than or equal to the first reference ratio, the control module 106 determines whether the display device 13 is moving. The control module 106 determines whether the display device 13 is moving by determining whether the motor or the roller axle 132 is running

For example, when the forward movement command has been sent to the motor and no stop command has been sent to the motor after the forward movement command, the control module 106 determines that the display device 13 is moving. The stop command is used to control the motor to stop running When the stop command has been sent to the motor after the forward movement command, the control module 106 determines that the display device 13 is not moving.

When the display device 13 is moving, step S20 is implemented. When the display device 13 is not moving, the procedure returns to step S10.

In step S20, the control module 106 sends the stop command to the motor and controls the motor to stop driving the roller axle 132. Thus, the display device 13 is stopped from moving forward, and the procedure ends.

In other embodiments, when the calculated ratio is greater than the first reference ratio, or a difference between the calculated ratio and the first reference ratio is greater than a predetermined value, the control module 106 sends a backward movement command to the motor, and controls the display device 13 to move backwards by controlling the motor to drive the roller axle 132 according to the backward movement command. For example, the roller axle 132 is controlled to roll backwards to move the display device 13 backwards. The backwards movement command is preset by the setting module 100. The calculation module 104 calculates the difference between the calculated ratio and the first reference ratio.

In other embodiments, a second reference ratio is set by the setting module 100 to determine whether the eyes of the user are closed. The second reference ratio may be determined based on a plurality of closed-eyes images acquired when the user's eyes are closed. Furthermore, other known technologies can be used to determine whether the eyes of the user are closed.

When one or more ratios calculated during a predetermined time period (e.g., 3 minutes) are less than or equal to the second reference ratio or fall within a preset error range of the second reference ratio, the control module 106 further controls the display device 13 to enter a sleep mode, so as to save power consumption.

Furthermore, the control module 106 controls the display device 13 to switch from the sleep mode to a working mode, when one calculated ratio is greater than the second reference ratio or exceeds the preset error range of the second reference ratio after the predetermined period.

By utilizing the control system 10, the movements of the display device 13 and the modes of the display device 13 can be controlled automatically by opening the eyes widely or normally, narrowing the eyes, or closing the eyes.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for moving a display device using an electronic device, the electronic device comprising an image capturing device and a storage device, the display device being supported by a bracket, which is connected to a roller axle and a motor, the storage device storing a first reference ratio of a height and a width of an eye area when eyes of a user are opened normally, the method comprising:
acquiring a facial image of the user at each predetermined time interval using the image capturing device;
calculating a ratio of a height and a width of an eye area recognized from the facial image;
sending a forward movement command to the motor and controlling the display device moving forward by controlling the motor to drive the roller axle according to the forward movement command, under the condition that the calculated ratio is less than the first reference ratio; and
sending a stop command to the motor and controlling the motor to stop driving the roller axle when an updated calculated ratio is greater than or equal to the first reference ratio.

2. The method according to claim 1, further comprising:
repeating the step of calculating a ratio of a height and a width of an eye area recognized from an updated facial image to calculate the updated calculated ratio, the updated facial image being acquired after a next predetermined time interval.

3. The method according to claim 1, wherein the first reference ratio is determined by:
acquiring a plurality of template images using the image capturing device when the eyes of the user are opened normally;
calculating a ratio of a height and a width of an eye area recognized from each of the plurality of template images to acquire a plurality of calculated ratios; and
determining an average value of the plurality of calculated ratios to be the first reference ratio.

4. The method according to claim 1, further comprising:
sending a backward movement command to the motor and controlling the display device moving backwards by controlling the motor to drive the roller axle according to the backward movement command, under the condition that the calculated ratio is greater than the first reference ratio or a difference between the calculated ratio and the first reference ratio is greater than a predetermined value.

5. The method according to claim 1, further comprising:
presetting a second reference ratio of a height and a width of an eye area when the eyes of the user are closed; and
controlling the display device to enter a sleep mode, when one or more ratios calculated during a predetermined time period are less than or equal to the second reference ratio or fall within a preset error range of the second reference ratio.

6. The method according to claim 5, further comprising:
controlling the display device to switch from the sleep mode to a working mode, when one calculated ratio is greater than the second reference ratio or exceeds the preset error range of the second reference ratio.

7. An electronic device comprising:
an image capturing device;
a display device being supported by a bracket, which is connected to a roller axle and a motor;
at least one processor; and
a storage devices storing a first reference ratio of a height and a width of an eye area when eyes of a user are opened normally, and storing a plurality of instructions, which when executed by the processor, causes the at least one processor to:
acquire a facial image of the user at each predetermined time interval using the image capturing device;
calculate a ratio of a height and a width of an eye area recognized from the facial image;
send a forward movement command to the motor and control the display device moving forward by controlling the motor to drive the roller axle according to the forward movement command, under the condition that the calculated ratio is less than the first reference ratio; and
send a stop command to the motor and control the motor to stop driving the roller axle when an updated calculated ratio is greater than or equal to the first reference ratio.

8. The electronic device according to claim 7, wherein the at least one processor further repeats the step of calculating a ratio of a height and a width of an eye area recognized from an updated facial image to calculate the updated calculated ratio, the updated facial image being acquired after a next predetermined time interval.

9. The electronic device according to claim 7, wherein the first reference ratio is determined by:
acquiring a plurality of template images using the image capturing device when the eyes of the user are opened normally;
calculating a ratio of a height and a width of an eye area recognized from each of the plurality of template images to acquire a plurality of calculated ratios; and
determining an average value of the plurality of calculated ratios to be the first reference ratio.

10. The electronic device according to claim 7, wherein the at least one processor further sends a backward movement command to the motor and controls the display device moving backwards by controlling the motor to drive the roller axle according to the backward movement command, under the condition that the calculated ratio is greater than the first reference ratio or a difference between the calculated ratio and the first reference ratio is greater than a predetermined value.

11. The electronic device according to claim 7, wherein the at least one processor further:
presets a second reference ratio of a height and a width of an eye area when the eyes of the user are closed; and
controls the display device to enter a sleep mode, when one or more ratios calculated during a predetermined time period are less than or equal to the second reference ratio or fall within a preset error range of the second reference ratio.

12. The electronic device according to claim 11, wherein the at least one processor further controls the display device to switch from the sleep mode to a working mode, when one calculated ratio is greater than the second reference ratio or exceeds the preset error range of the second reference ratio.

13. A non-transitory storage medium having stored thereon instructions that, when executed by a processor of an electronic device, causes the electronic device to perform a method for moving a display device using an electronic device, the electronic device comprising an image capturing device and a storage device, the display device being supported by a bracket, which is connected to a roller axle and a motor, the storage device storing a first reference ratio of a height and a width of an eye area when eyes of a user are opened normally, the method comprising:
acquiring a facial image of the user at each predetermined time interval using the image capturing device;
calculating a ratio of a height and a width of an eye area recognized from the facial image;
sending a forward movement command to the motor and controlling the display device moving forward by controlling the motor to drive the roller axle according to the forward movement command, under the condition that the calculated ratio is less than the first reference ratio; and
sending a stop command to the motor and controlling the motor to stop driving the roller axle when an updated calculated ratio is greater than or equal to the first reference ratio.

14. The non-transitory storage medium according to claim 13, wherein the method further comprises:
repeating the step of calculating a ratio of a height and a width of an eye area recognized from an updated facial image to calculate the updated calculated ratio, the updated facial image being acquired after a next predetermined time interval.

15. The non-transitory storage medium according to claim 13, wherein the first reference ratio is determined by:
acquiring a plurality of template images using the image capturing device when the eyes of the user are opened normally;
calculating a ratio of a height and a width of an eye area recognized from each of the plurality of template images to acquire a plurality of calculated ratios; and
determining an average value of the plurality of calculated ratios to be the first reference ratio.

16. The non-transitory storage medium according to claim 13, wherein the method further comprises:
sending a backward movement command to the motor and controlling the display device moving backwards by controlling the motor to drive the roller axle according to the backward movement command, under the condition that the calculated ratio is greater than the first reference ratio or a difference between the calculated ratio and the first reference ratio is greater than a predetermined value.

17. The non-transitory storage medium according to claim 13, wherein the method further comprises:
presetting a second reference ratio of a height and a width of an eye area when the eyes of the user are closed; and
controlling the display device to enter a sleep mode, when one or more ratios calculated during a predetermined time period are less than or equal to the second reference ratio or fall within a preset error range of the second reference ratio.

18. The non-transitory storage medium according to claim 13, wherein the method further comprises:
controlling the display device to switch from the sleep mode to a working mode, when one calculated ratio is greater than the second reference ratio or exceeds the preset error range of the second reference ratio.
